(19) United States
(12) Patent Application Publication
(10) Pub. No.: US 2009/0021343 A1
(43) Pub. Date: Jan. 22, 2009

(54) RFID Intrusion Protection System and Methods

(75) Inventor: Amit Sinha, Marlborough, MA (US)

Correspondence Address: CLEMENTS BERNARD MILLER, 1901 ROXBOROUGH ROAD, SUITE 300, CHARLOTTE, NC, 28211, US

(73) Assignee: AIRDEFENSE, INC., Alpharetta, GA (US)

(21) Appl. No.: 11/382,590

(22) Filed: May 10, 2006

(51) Int. Cl. G05B 19/04

(52) U.S. Cl. 340/5.2

(57) ABSTRACT

Systems and methods for RFID intrusion protection are defined. The system uses RFID sensors coupled with one or more servers to detect unauthorized scanning or programming of RFID tags. The system has active defense mechanisms to block unauthorized communications between a rogue RFID reader and one or more tags. Special IPS tags implement active defenses and log activity for tags that are not within the protected perimeter or in transit.

### CROSS-REFERENCE

This application further incorporates by this reference in their entirety for all purposes commonly assigned U.S. patent applications filed Jun. 3, 2002;

| Application | |
|---|---|
| No. | Title |
| 10/161,142 | “SYSTEMS AND METHODS FOR NETWORK |
| | SECURITY” |
| 10/161,440 | “SYSTEM AND METHOD FOR WIRELESS |
| | LAN DYNAMIC CHANNEL CHANGE WITH |
| | HONEYPOT TRAP” |
| 10/161,443 | “METHOD AND SYSTEM FOR ACTIVELY |
| | DEFENDING A WIRELESS LAN AGAINST |
| | ATTACKS” |
| 10/160,904 | “METHODS AND SYSTEMS FOR |
| | IDENTIFYING NODES AND MAPPING |
| | THEIR LOCATIONS” |
| 10/161,137 | “METHOD AND SYSTEM FOR ENCRYPTED |
| | NETWORK MANAGEMENT AND INTRUSION |
| | DETECTION” |

Furthermore, this application incorporates fey reference for all purposes, commonly assigned U.S. patent applications filed Nov. 4, 2003:

| Application | |
|---|---|
| No. | Title |
| 10/700,842 | “SYSTEMS AND METHODS FOR AUTOMATED |
| | NETWORK POLICY EXCEPTION DETECTION AND |
| | CORRECTION” |
| 10/700,914 | “SYSTEMS AND METHOD FOR DETERMINING |
| | WIRELESS NETWORK TOPOLOGY” |
| 10/700,844 | “SYSTEMS AND METHODS FOR ADAPTIVELY |
| | SCANNING FOR WIRELESS COMMUNICATIONS” |

Furthermore, this application incorporates by reference for all purposes, commonly assigned U.S. patent applications Hied Feb. 6, 2004:

| Application | |
|---|---|
| No. | Title |
| 10/774,034 | “SYSTEMS AND METHODS FOR ADAPTIVE |
| | LOCATION TRACKING” |
| 10/774,111 | “WIRELESS NETWORK SURVEY SYSTEMS AND |
| | METHODS” |
| 10/774,896 | “SYSTEMS AND METHODS FOR ADAPTIVE |
| | MONITORING WITH BANDWIDTH CONSTRAINTS” |
| 10/774,915 | “DYNAMIC SENSOR DISCOVERY AND SELECTION |
| | SYSTEMS AND METHODS” |

Furthermore, this application incorporates by reference for all purposes, commonly assigned U.S. patent applications filed Oct. 19, 2005:

| Application | |
|---|---|
| No. | Title |
| 11/253,316 | “PERSONAL WIRELESS MONITORING AGENT” |

Furthermore, this application incorporates by reference for all purposes, commonly assigned U.S. patent applications filed Jan. 13, 2006:

| Application | |
|---|---|
| No. | Title |
| 11/332,065 | “SYSTEMS AND METHODS FOR WIRELESS |
| | INTRUSION DETECTION USING SPECTRAL |
| | ANALYSIS” |

Furthermore, this application incorporates by reference for all purposes, commonly assigned U.S. patent applications filed Mar. 17, 2006:

| Application | |
|---|---|
| No. | Title |
| 11/276,925 | “SYSTEMS AND METHODS FOR WIRELESS |
| | SECURITY USING DISTRIBUTED COLLABORATION |
| | OF WIRELESS CLIENTS” |
| 11/276,930 | “SYSTEMS AND METHODS FOR WIRELESS |
| | NETWORK FORENSICS” |

### BACKGROUND AND SUMMARY

The present disclosure is directed to systems and methods for wireless security. More specifically, without limitation, to systems and methods for intrusion protection for radio frequency identification (RFID) networks.

RFID stands for radio frequency identification. RFID is an automatic identification method, relying on storing and retrieving data through a wireless connection date using devices called RFID tap or transponders. An RFID tag includes integrated circuitry and antennas configured to receive and transmit data to radio frequency queries from an RFID transceiver such as, for example, an RFID reader or scanner. The integrated circuitry may be configured to transmit identification data responsive to a query from a reader device. The RFID reader can be configured to communicate with a server to transmit data.

A typical RFID system, includes multiple RFID tags attached to objects, humans, or animals; multiple readers; and computer storage and processing, equipment in communication with the multiple readers. RFID tags may be attached for purposes of tracking and identification.

RFID systems can be used for a variety of applications including remote keyless entry, animal tracking, payment systems, highway toll collection, building access, and supply chain management. RFID systems offer significant advantages in supply chain management. Producers can attached a tag to a product in the manufacturing stage, allowing the product to be monitored in shipment, in-store, and finally after a consumer purchases it. While RFID systems provide benefits, they also pose threats to security and privacy.

RFID systems operate wirelessly, typically in the unlicensed portion, of the wireless spectrum. Some passive RFID tags operate in the low-frequency band (125-134.2 KHz), such as access cards. These tags typically have a range of less than 1 m. Passive tags operating in the UHF band (915 MHz) can be read at 10 m or more in free space, but this range diminishes when tags are attached to something. RFID tags are promiscuous and do not require authorization to interrogate.

In the context of the supply chain, RFID provides tremendous value in allowing individual products to be tracked and identified from manufacturing to retail and finally to end users. However, the promiscuous nature of tags allows for threats to privacy and security. Competitors can infiltrate the supply chain by accessing tag information through an unauthorized reader located nearby. For example, a cargo shipping container can be scanned to determine the contents or a warehouse can be in filtrated to determine the supply level.

The present disclosure provides systems and methods for RFID intrusion protection through RFID sensors to monitor and defend the RFID infrastructure; through servers to store, analyze, and direct sensors to defend the RFID infrastructure; and through intrusion protection system tags to protect tags in transit or on an individual object or person.

A method, for monitoring radio frequency identification (RFID) networks for intrusion and policy violations with RFID sensors can include: setting configuration and policy information; scanning for RFID transmissions; logging statistics to a data, store over a set time interval; generating an alarm responsive to any of intrusions and policy violations; and repeating the scanning through generating steps.

A radio frequency identification (RFID) sensor can include: an antenna configured to receive and transmit wireless transmissions of signals in an adjustable range of frequencies; memory capable of storing received data and program data; a system processor comprising one or more processing elements, wherein the system processor is in communication with the antenna and the memory and wherein the system processor's one or more processing elements are programmed or adapted to: i) extract RFID data into one or more logical units from signals received by the antenna; ii) inspect each extracted logical unit; and iii) store information derived from the inspection of each logical unit in memory.

A server-based method for monitoring radio frequency identification (RFID) networks for intrusion and policy violations can include obtaining configuration and policy information; establishing communication with a plurality of RFID sensors; receiving events from the plurality of RFID sensors; correlating events from the plurality of RFID sensors; and generating an alarm responsive to the correlating step; and repeating the receiving through generating steps.

A radio frequency identification (RFID) intrusion protection system can include a local intrusion protection server connected to a network; a data store connected to the server; wherein the server is configured to: establish communications with a plurality of RFID sensors connected to the network; obtain configuration and policy from the network and RFID infrastructure connected to the network; receive events and statistics from the plurality of RFID sensors; store events and statistics in the data store; and correlate events to identify RFID readers, policy violations, and intrusions.

A tag-based method of intrusion protection for radio frequency identification (RFID) networks cm include: initializing an intrusion protection RFID tag; and activating a defense responsive to the RFID signature, the defense comprising one of a jamming signal and a collision signal.

An intrusion protection radio frequency identification (RFID) tag configured to protect RFID tags located substantially in the same vicinity as the intrusion protection RFID tag can include an antenna configured to transmit and receive RFID communications at a set frequency, the frequency responsive to the RFID protocol; a processor coupled to the antenna, the processor configured to: detect RFID signatures; and transmit a jamming or a collision signal responsive to an RFID signature.

### BRIEF DESCRIPTION OF THE DRAWINGS

FIG. 1 illustrates a radio frequency identification (RFID) system as is known in the art.

FIGS. 2A-2C are tables and examples of RFID tags illustrating attributes relating to technical, security, and physical features

FIG. 3 illustrates potential threats associated with RFID systems with regards to item management.

FIG. 4 is a block diagram of an exemplary embodiment of a local intrusion protection system for RFID systems.

FIG. 5 is a block diagram of an exemplary embodiment of a master intrusion protection system for RFID systems.

FIGS. 6A-6B are schematic diagrams of an exemplary embodiment of a reader/sensor and a sensor.

FIGS. 7A-7B are a flowcharts illustrating an operational scenario of an RFID sensor scanning an RFID network and communicating with an intrusion detection server.

FIG. 8 is a flowchart illustrating an operational scenario of an RFID sensor implementing defenses in an RFID system.

FIG. 9 is a flowchart illustrating an operational scenario of a local or master intrusion detection server.

FIG. 10 is a block diagram of an exemplary embodiment of an RFID system including an intrusion protection system tag for defending against RFID tag interrogation.

FIGS. 11A-11B are schematic diagrams of exemplary embodiments of an intrusion protection system (IPS) tag.

FIG. 12 is a flowchart illustrating an operational scenario of an intrusion protection system (IPS) tag.

FIG. 13 is a flowchart illustrating an operational scenario of an intrusion protection system (IPS) tag synchronising with an intrusion protection server.

### DETAILED DESCRIPTION

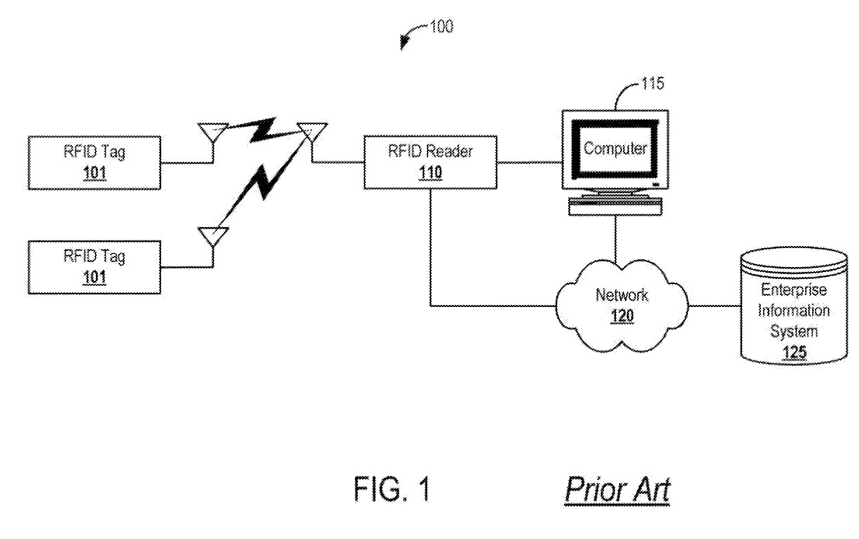

FIG. 1 illustrates, a radio frequency identification (RFID) system 100 as is known in the art. The RFID system 100 is used for identifying and tracking objects, animals, or people. The RFID system 100 includes one or more RFID readers 110 and multiple RFID tags 101 attached or embedded in objects, animals, or people. The RFID tag 101 can be programmed with a unique identification code. Additionally, this identification code is entered into a computer 115, an enterprise information system 125, or the RFID reader 110 for future recall.

The RFID tags 101 are configured to wirelessly receive a query from the RFID reader 110 and to transmit data in response to the query. The data can include the unique identification code or other identification information such as, for example, product type, serial number, quantity, access level, etc. In the case of the unique identification code, the RFID reader 110 synchronizes with the computer 115 or the enterprise information system 125 to determine the identification information associated with the unique identification code. Examples of RFID readers 110 include a handheld scanner, a stationary scanner, and a card reader, among others.

RFID tags 101 are promiscuous and do not have internal memory to track previous scans. Additionally, RFID tags 101 can be deactivated to prevent further reading of the tag. For example, RFID tags 101 can be used in commercial transactions as theft deterrents with RFID readers 110 located at foe exits to the stores configured to alert the store when a tag 101 passes through the reader 110. At the point of sale, the RFID tag 101 on store merchandise can be deactivated after check out.

The RFID reader 110 is configured to scan RFID tags 101, to receive data from the RFID tags 101, to store the received data, and to communicate the data externally. For example, the RFID reader 110 can interface a computer 115, a network 120, and an enterprise information system 125. The network 120 can be an internet protocol (IP) network such as an Ethernet network. The RFID reader 110 can include a direct network connection such as an Ethernet port or a direct computer connection such as a universal serial bus (USB) connection. The RFID reader 110 can transmit the received data to the computer 115 or the enterprise information system 125. Additionally, the RFID reader 110 can receive communications from the computer 115 and the enterprise information system 125 such as software updates and scanning instructions.

The enterprise information system 125 is configured to store and process received data from multiple readers 110 and to correlate the data from RFID tags 101 to the data stored in the system l25. The enterprise information system 125 can be used in manufacturing and inventory applications such as product tracking. For example, data for a box of products such as product type, serial number, quantity, etc. can be entered into the system 125 based on the RFID tag 101 attached to the box. The RFID reader 110 can correlate the contents of the box based on the Identification code received from a scan of the RFID lag 101 and the data in the system 125.

The computer 115 can be used to locally access and process the received data from the RFID reader 110. For example, a point of sale checkout system includes a scanner and a processor providing the functionality of the RFID reader 110 and the computer 115. The point of sale checkout system is configured to read the RFID tag 101 on each item for purposes of determining the cost of the goods for a person.

RFID tags 101 may be attached to or incorporated into a product, an animal, or a person for. RFID tags 101 enable tracking and identification of any object, person, or animal to which, the tag is attached or located in. The use of RFID tap 101 have proliferated with the low cost Introduction of RFID tags 101, readers 110, and the associated computing equipment 115, 125 for tracking and identification.

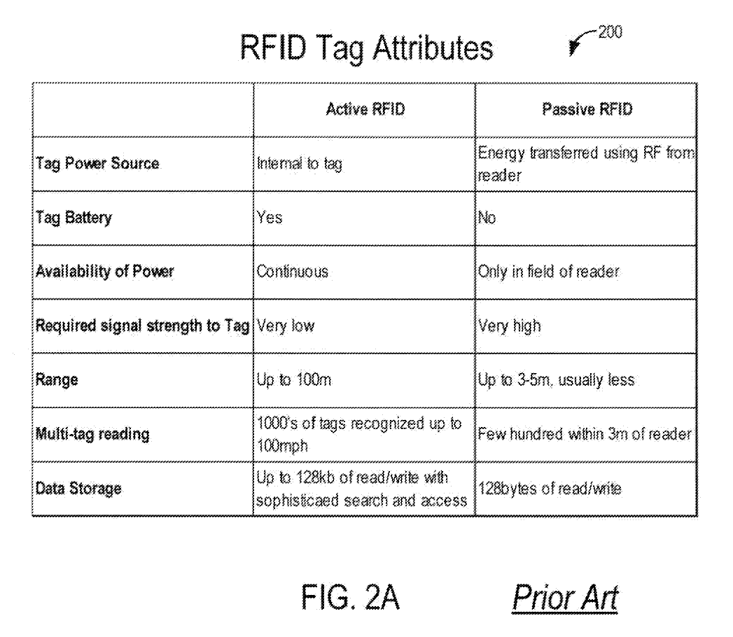

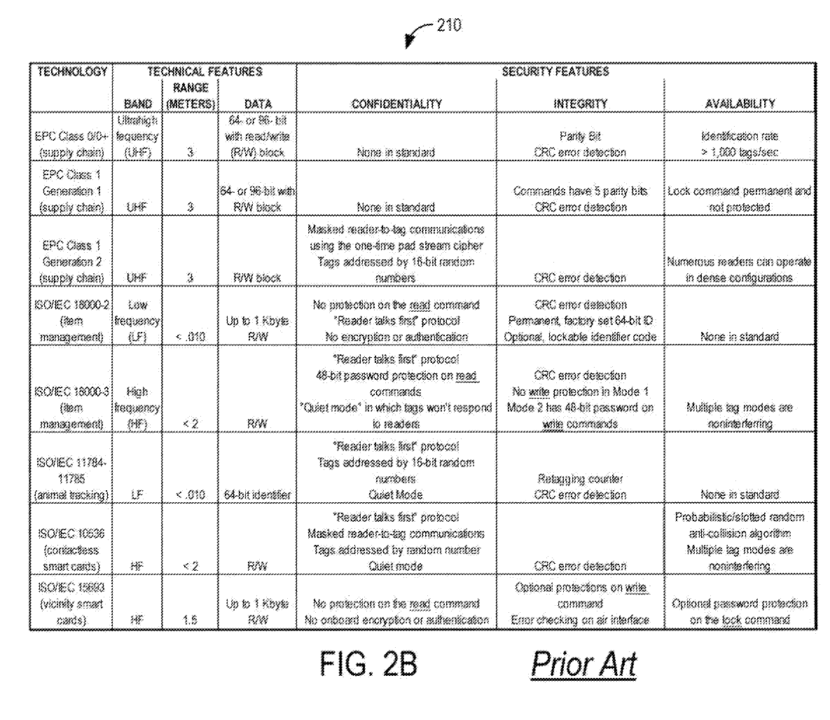

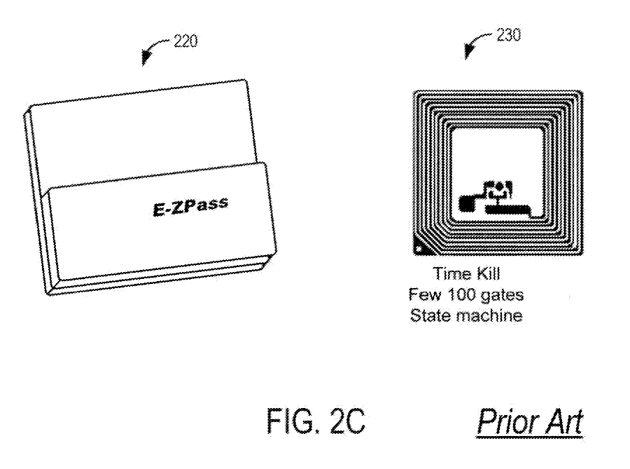

FIG. 2A is a table 200 of the attributes of passive and active RFID tags 101. RFID tags 101 can generally be classified into either passive or active depending on whether the tag contains internal power. Active tags include internal power such as, for example, a battery or an AC adaptor. Passive tags do not include internal power, and instead receive power from, the attached antenna when an RFID reader 110 is scanning. Additionally, RFID tags 101 can also be semi-passive where there is some limited internal power.

Active RFID tags 101 have internal power for the integrated circuitry and for transmitting a response. Active RFID tags 101 are also known as beacons. Due to the continuous power, active RFID tap 101 have longer ranges and larger memories. Active RFID tags 101 can also transmit more complex, responses to reading. Examples of active RFID tags 101 include an automated toll collection tag, a locator beacon, a global positioning satellite (GPS) locator beacon, among others.

Passive RFID tags 101 do not include internal power, and instead rely on the energy transfer from the radio frequency (RF) signal of the RFID reader 110. The incoming RF signal induces electrical current in the antenna to provide enough power for the integrated circuitry to transmit a response. The antenna in a passive RFID tag 101 is configured to both collect power from the incoming signal and to transmit the outbound signal. The transmitted data can include an identification number. Passive RFID tags 101 can also include a nonvolatile EEPROM (electrically erasable programmable read-only memory) for storing data. This EEPROM may be erased to remove the identification data. For example, a passive RFID tag 101 can be erased when a product is purchased. The tag may be erased by a reader providing an instruction, to the tag. Examples of passive RFID tags 101 include a label attached to a commercial product, a theft, deterrent device attached to a product, an access badge, among others.

Semi-passive RFID tags 101 are similar to passive RFID tags 101 but include a small battery for power. The battery provides constant power and removes the need for the antenna to collect power. Therefore, the antenna can be optimized solely for transmission allowing a semi-passive RFID tag 101 to respond faster and stronger to an RFID reader 110.

Passive RFID tags 101 vary in size from about 2 mm to a few meters. Semi-passive RFID tags 101 are similarly sized with a small battery. Passive RFID and semi-passive RFID tags 101 are relatively inexpensive to manufacture and may be used in a variety of applications such as Inventory management, payment systems, and product tagging, among others. Passive RFID tags 101 allow companies to replace die UPC (universal product codes) in a retail context for quicker cheek out at the cash register. Companies can use passive and semi-passive RFID tags 101 for inventory management to track products and shipments. Additionally, passive and semi-passive RFID tags 101 may provide theft deterrence by alerting store personnel if someone leaves a store with an active tag.

FIG. 2B is a table 210 listing examples of the technology-RFID tags 101 and the associated technical and security features. Examples of RFID tag 101 standards include the electronic product code (EPC), the Internal Organization for Standardization (ISO), and the International Electrotechnical Commission (IBC).

The EPC is an RFID system meant to be an improvement to the current universal product, code (UPC) barcode system. The BPC is a 64- or 96-but code based on a numbering scheme. The EPC is divided into numbers that differentiate the product and manufacturer of a given item. EPC provides extra manners to allow for die unique identification of any one item. A typical EPC number includes a header, identifying the length, type, structure, version, and generation, of EPC; a manager number identifying the company or entity; an object class similar to a stock keeping unit (SKU); and a serial number which is meant, to attach to the unique item. The EPC is the emerging standard for global RFID usage with regards to product and inventory management. The EPC is a creation of the Massachusetts Institute of Technology (MIT) Auto-ID Center which is a consortium, of over 120 global corporations and university labs, and is managed by E PC-global, Inc. of Lawrenceville, N.J.

The EPC Class 0 and 1 tags operate in the ultrahigh frequency (UHF) band and provide a 64- or 96-bit code. The range of typical. EPC Class 0 and 1 tap is around three meters. However, this range can be extended with higher transmit power in the RFID reader. EPC Class 0 and 1, generation 1 do not include confidentiality. BPC Class 1, generation 2 has introduced masked reader-to-tag communications using a one-time pad stream cipher. All EPC Class tags utilised cyclical redundancy check (CRC) for error detection and for deactivation. From an availability perspective, multiple readers can operate in dense configurations and read multiple tags over a short period of time as is required in the supply chain application.

The ISO/IEC 18000-2 and 3- are international, standards specifying RFID technology for Item Management, Both ISO/IEC 18000-2- and 3 describes the air interface, i.e. the communication between the interrogator and the tags (or transponders) by the mean of radio frequency; ISO/IEC 18000-2 operates at radio frequencies less than 135 kite (generally referred to as low frequency or LF). ISO/IEC 18000-3 operates at 13.56 MHz (generally referred to as high frequency or HF). The functionalities include read, and write, and an anti-collision mechanism that allows for quasi-simultaneous identification of several tags present in the field of the reader antenna. The system is “interrogator-talks-first”, which prevents interference with other RFID systems working at same or similar frequencies.

Additional applications for RFID systems include animal tracking, contactless smart cards, and vicinity smart cards. Table 210 includes examples of ISO/IEC standards for these applications. ISO/IEC 11784-11785 operates in the LF frequency range and operates at short distances. An application of ISO/IEC 11784-31785 is the fagging of animals for tracking. ISO/IEC 10536 defines a standard for contactless smart cards operating in the HF frequency range at a distance around 2 m. Finally, ISO/IEC 15693 defines a standard for vicinity smart cards operating in the HF frequency range at a distance around 1.5 m.

The exemplary standards in table 210 highlight that existing RFID systems include little or no security or confidentiality features. The focus in the standards bodies has been on availability and error detection as opposed to intrusion prevention through unauthorized reading of tags.

FIG. 2C illustrates two example embodiments of RFID tags 101. RFID tag 220 is an active tag used in automobiles to automatically, pay tolls on roads without requiring a driver to stop or slow down. The RFID tag 220 includes a local power supply such as a battery, and it broadcasts a unique identifier to a reader 110 that is located at a highway toll facility. The RFID tag 230 is a passive RFID tag typical of an EPC tag or an ISO/IEC 18000 item management tag. Tag 230 has relatively low cost to manufacture and can be affixed to a product at any stage in manufacturing to track and identify the object.

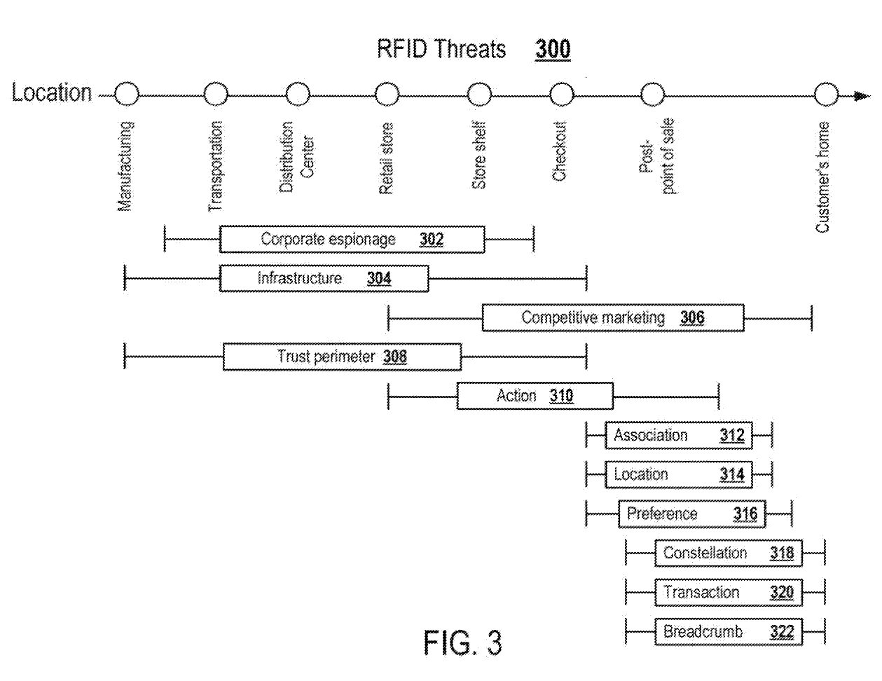

FIG. 3 illustrates potential threats 300 associated with RFID systems with regards to item management. RFID offers the opportunity to track and identify tagged objects throughout the supply chain, i.e. from manufacturing to the customer. Tags are promiscuous in that the can be read by any reader at the correct frequency and operating parameters and they do not store a record of prior queries. The threats 300 listed in FIG. 3 are illustrative of risks in the EPC network.

Corporate espionage 302 can occur between manufacturing to before checkout. A rogue reader can interrogate tap to gather supply chain data. Further because tagged objects contain unique identification information, it is easier for competitors to gain insight into the supply chain through rouge interrogation. The RFID infrastructure 304 is also at risk to wireless disruptions which can affect the supply chain. For example, jamming signals or denial-of-service attacks could disrupt supply chain operations.

Competitive marketing 306 can enable a rogue reader to gain insight into customer preferences from the retail store through the customer's home. For example, a rogue reader can interrogate and track the purchasing habits of customers. The thrust perimeter 308 threat increases the threat to the supply chain as new attacks emerge to affect the wireless space.

The action 310 threat involves inferring an individual's behavior my monitoring the action of a group of tags. For example, tags on objects on a retail shelf could disappear and the inference could be of a potential threat when in fact the tags were deactivated or fell off die objects accidentally.

The association 312 threat occurs when a customer purchases an object with a tag. For example, customer loyalty programs enable retailers to the customers to objects at the serial number level. The location 314 threat exists when a tag leaves retail without being deactivated. The tag enables unauthorized tracking of both the individual and the object. The preference 316 threat is similar to the association 312 threat and offers potential risk to a person that her purchases could be disclosed to an unauthorized reader and pose a threat to theft or safety.

The constellation 318 threat also allows unauthorized tracking of a person with multiple RFID tags. The tags form a unique RFID shadow or constellation around the person. A rogue reader can use this constellation to track the person. The transaction 320 threat infers a transaction between people when a tagged object moves from one constellation to another. Finally, the breadcrumb 322 threat is a consequence of association. A person with multiple tags and association creates so-called electronic breadcrumbs tracking and identifying their location and purchasing preferences.

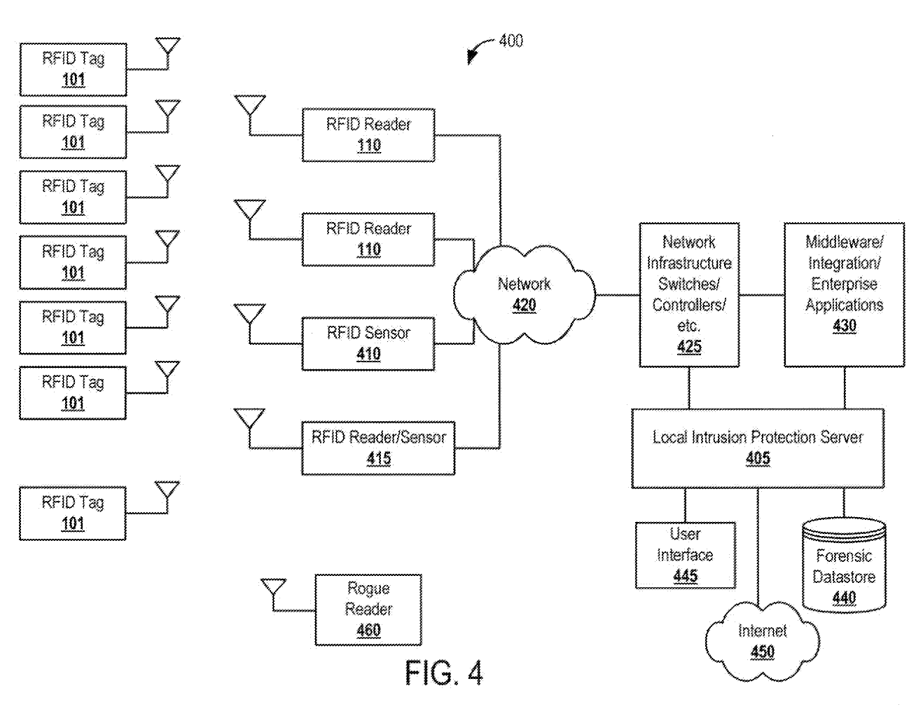

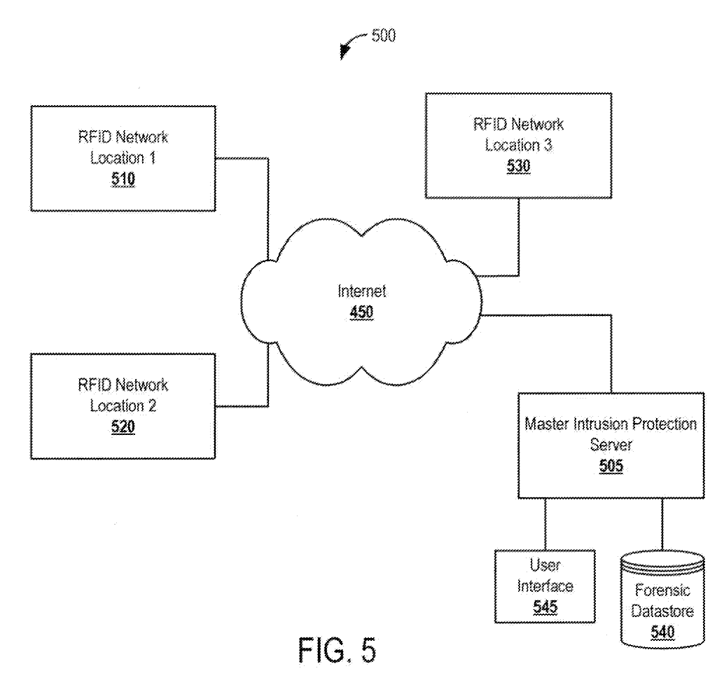

FIG. 4 is a block diagram of an exemplary embodiment Of a local, intrusion protection system 400 for RFID systems. There are multiple RFID tags 101 which can be tied to objects such as, for example, Inventory items in: a warehouse. RFID readers 110 are used to scan the RFID tags 101 to gather identification data. The local system 400 is configured to monitor a single RFID infrastructure such as, for example, a warehouse, shipping depot, department store, etc. The Ideal system 400 may connect to a master system 500 through the Internet 450 as described in FIG. 5.

RFID readers 110 connect to middleware/integration/enterprise applications 430 through a network 420. The applications 430 include software and databases configured to manage the relationship between the RFID tags 101 and the objects in which the tags 101 are tagged to. The network 420 can include an Ethernet or a Wireless local area network. Additionally, readers 110 can interface direct to the applications 430 through direct connections such as a universal serial bus (USB) connection.

The local intrusion protection system 400 includes & local intrusion protection server 405, RFID sensors 410, RFID readers/sensors 415, and a forensic data store 440. Sensors 410 and readers/sensors 415 are distributed throughout the physical infrastructure where the RFID tags 101 are located. The sensors 410 and readers/sensors 415 are configured to monitor wireless RFID transmissions, to enforce RFID policy, and to communicate with the server 405. The server 405 analyzes RFID transmissions and directs the sensors 410 and readers/sensors 415 to enforce policies. Additionally, the server 405 can be connected to the data store 440 to track statistics for forensic analysis of the RFID system. Examples of statistics include, the number of scans per minute, types of tags used, number of tags disabled, active scanner count, unknown/unauthorized scan count, among others.

The RFID sensor 410 is essentially an RFID reader 110 modified to perform extra functionality such as: detecting other RFID readers 110 querying RFID tags 101 in the vicinity, transmitting spoofed RFID tag 101 responses at adjustable power levels, jamming RFID communications, and communicating securely with the server 420. The sensor 410 receives policy and configuration information from the server 420 and sends alarms, statistics, and events in the RFID system to the sever 420. The sensor 410 can be configured to transmit at adjustable output power levels to allow the range of transmission to be controlled as well as better spoofing tag responses when required to actively defend against an intrusion.

Readers/sensors 415 are configured to perform the same essential functionality of the sensor 410 and additionally are configured as standard RFID readers 110 with the functionality to interrogate RFID tap 101. Both sensors 410 and readers/sensors 415 can be either stationary or mobile devices throughout the physical infrastructure where RFID tags 101 are located.

The server 405 is connected to multiple sensors 410 and readers/sensors 415 through the network 420. The network 420 can include a local area network (LAN) such as ah Ethernet or a wireless LAN. The sever 405 can include an Intel-compatible processor platforms, such as those using at least one Pentium III or Celeron (Intel Corp., Santa Clara, Calif.) class processor; it should be understood that other processors such as UltraSPARC (Sun Microsystems, Palo Alto, Calif.) could be used in other embodiments. The server 405 includes a network connection such as, an Ethernet or wireless card to enable the communication to the network 420.

The server 405 obtains network configuration information manually or automatically foam the RFID infrastructure through communication with the sensors 410 and readers/sensors 415. This configuration information can include authorized readers 110, protocols, reader 110 physical locations, user privileges, policy, protocols, and network and system settings. The server 405 also obtains policy information manually or automatically from the sensors 410 and readers/sensors 415. Policy information can include information such as system usage times, tag lock or kill policy, tag write policy, and query thresholds.

The server 405 configures the sensors 410 and readers/sensors 415 with configuration information automatically or manually based on user settings. The server 405 receives information from sensors 410 and readers/sensors 415, and analyzes the information to determine if a rogue reader 460 is reading or writing tags based on correlation, policy violation, anomalous behavior, protocol abuse or signature detection. The rogue reader 400 is any RFID reader that, is not sanctioned or authorized to interrogate tags in a particular environment.

In response to a rogue reader 460, the server 405 can activate policy based defenses using one or more RFID sensors 410 or readers/sensors 415 to spoof tag response, to jam the RFID channel, or to program tags into a quiet mode. A spoofed tag response directs the sensor 410 to transmit incorrect information, in response to a query from the rogue reader 460. Jamming the RFID channel disrupts all RFID communications. Finally if the tags are capable of a quiet mode, the server 405 can direct the tags 101 through the sensors 410 to not respond to RFID queries.

Additional functions of the server 405 include locating both authorized 101 readers and rogue readers 460 on a map by determining the physical location through wireless triangulation techniques known in the art. The server 405 does this through identifying the reader 110, 460 through multiple sensors 410 or readers/sensors 415. The server 405 also generates intrusion detection alarms using simple network management protocol (SNMP) traps, syslog messages, email, short message service (SMS) alerts, or any other messaging interface.

The server 405 includes a user interface (UI) 445 to provide user access to the server 405 for setting of configuration information; retrieval of alarms, performance history, and forensic analysis; and setting of policy information. The UI 445 can include a local interface to the server 405 such as, for example, a monitor and keyboard. Additionally, the UI 445 can include a remote interface such as, for example, web-based graphical UI that is accessed through a network connection to the server 405.

A forensic data store 440 is connected to the server 405 to log all RFID activity information. The data store 440 can include a hard drive either internal or external to the server 405 or a network-based storage device connected to the server 405 through the network 420. The forensic data store 440 operates to efficiently store all RFID activity and provide historical analysis as described in detail by U.S. patent application Ser. No. 11/276,930 entitled “SYSTEMS AND METHODS FOR WIRELESS NETWORK FORENSICS” filed Mar. 17, 2006, which has been incorporated by reference.

FIG. 5 is a block diagram of an exemplary embodiment of a master intrusion protection system 500 for RFID systems. The system 500 includes four RFID local intrusion protection systems 510, 520, 530, 540. Each of the local systems 510, 520, 530, 540 includes the components described in the system 400 of FIG. 4. For example, the local systems 510, 520, 530, 540 can include warehouses at separate physical locations or the entire supply chain from manufacturing through shipment.

The local systems 510, 520, 530, 540 connect to a master intrusion protection system 505 through the Internet 450. The server 505 is configured to centrally manage various site specific RFID systems 400. The server 505 is operable to perform the same functionality as the server 405 of FIG. 4, however the server 505 can be configured for higher performance and bandwidth based on the amount of local systems 400. System intelligence and forensic analysis can be adaptively scaled between the master server 505 and the local servers 405 based on bandwidth and resource constraints.

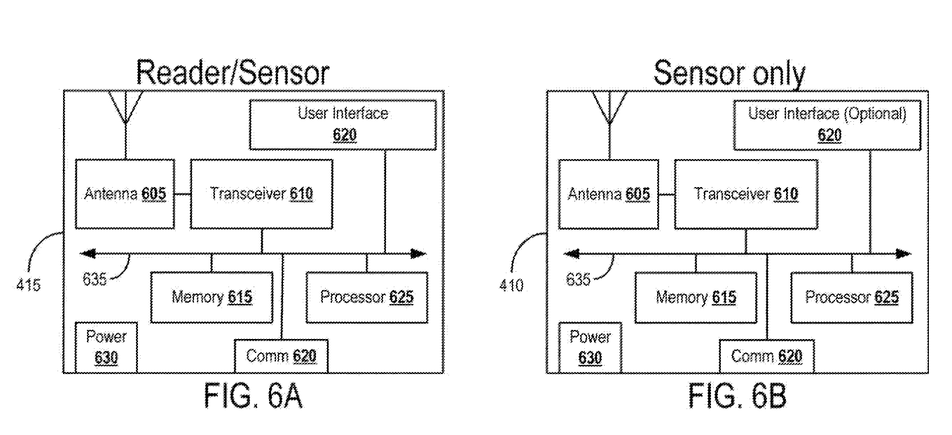

FIGS. 6A-6B are schematic diagrams of an exemplary embodiment of a reader/sensor 415 and a sensor 410. Both the reader/sensor 415 and the sensor 410 include an antenna 605, a transceiver 610, memory 615, a communications interlace 620, a processor 625, and power 630. Optionally, a user Interface (UI) 620 is included to allow local, access to the sensor 410 or the reader/sensor 415. The components 610, 615, 620, 625 communicate through a local interface 635. The local interface 635 can be, for example but not limited to, one or more buses or other wired or wireless connections, as is known in the art. The local interface 635 may have additional elements, Much are omitted for simplicity, such as controllers, buffers (caches), drivers, repeaters, and receivers, among many others, to enable communications. Further, the local interface 635 may include address, control, and/or data connections to enable appropriate communications among the aforementioned components.

The antenna 605 is configured to receive RFID queries and tag responses and is set in a promiscuous mode to operate continuously over a set frequency range. The frequency range may be adjusted depending on the enabled RFID communications. This adjustment can occur through the server 405, 505 or direct through the UI 620. For example, the frequency range can be set to the UHF range if the tags in its vicinity are EPC class 0/1 tags. Additionally, sensors 410 and reader/sensors 415 can be manufactured with specific antennas based on the application if adjustable frequency ranges are not required. For example, all RFID tags in the vicinity may operate at a set frequency and monitoring of other frequencies is not required to protect the RFID tags.

The transceiver 610 is configured to operate the antenna 605 and to communicate to the other components 615, 620, 625 through the local interface 635. The transceiver includes analog and digital circuitry to convert analog-to-digital and digital-to-analog signals for reception and transmission on the antenna 605.

The processor 625 is a hardware device for executing software instructions. The processor 625 can be any custom made or commercially available processor, a central processing unit (CPU), an auxiliary processor among several processors associated with sensor 410 and reader/sensor 415, a semiconductor-based microprocessor (in the form of a microchip or chip set), or generally any device for executing software instructions. When the sensor 410 and reader/sensor 415 is in operation, the processor 625 is configured to execute software stored within the memory 615, to communicate data to and from the memory 615, and to generally control operations of the sensor 410 and reader/sensor 415 pursuant to the software instructions.

The processor 625 is configured to analyse and parse through received RFID communications and to store the analysis in the memory 615. For example, the processor 625 can flag RFID communications that violate policy Information or that are based on unauthorized readers. For authorized communications, the processor can compile statistics to provide to the server 405, 5050.

The memory 615 can include any of volatile memory elements (e.g., random access memory (RAM, such, as DRAM, SRAM, SDRAM, etc.)), nonvolatile memory elements (e.g., ROM, hard drive, tape, CD ROM, etc.), and combinations thereof. The size of the memory 615 is set according to the amount of local storage needed prior to communications to the servers 405, 505.

The sensor 410 and reader-sensor 415 is configured with memory 615 to store the firmware, to store configuration data, and to store monitored RFID data. The firmware provides the operating instructions of the sensor 410 and reader/sensor 415. The configuration data is received through the communications interface 620 and is stored in the memory 615. Finally, the sensor 410 and reader/sensor 415 stores monitored data and statistics in the memory 615.

The communications interface 620 is used to communicate with the servers 405, 505. The interlace 620 can include an Ethernet adaptor or a Wireless card. Additionally, the interface 620 can include a local interface such as an RS-232 serial port for local access to the UI 620. The sensor 410 and reader/sensor 415 provides the server 405, 505 with data and statistics relating to the RFID system, for example, the sensor 410 and reader sensor 415 does not relay all RFID transmissions to the server 405, 505, but instead communicates unauthorized transmissions, policy violations, and overall statistics.

Local power 630 is included in the sensors 410 and reader sensors 415 for powering the devices. The power 630 can include an AC adaptor or a battery pack. Additionally, the power 630 can be through power over Ethernet based on the 802.3af standards. Here, the power 630 is connected to the communications interlace 620.

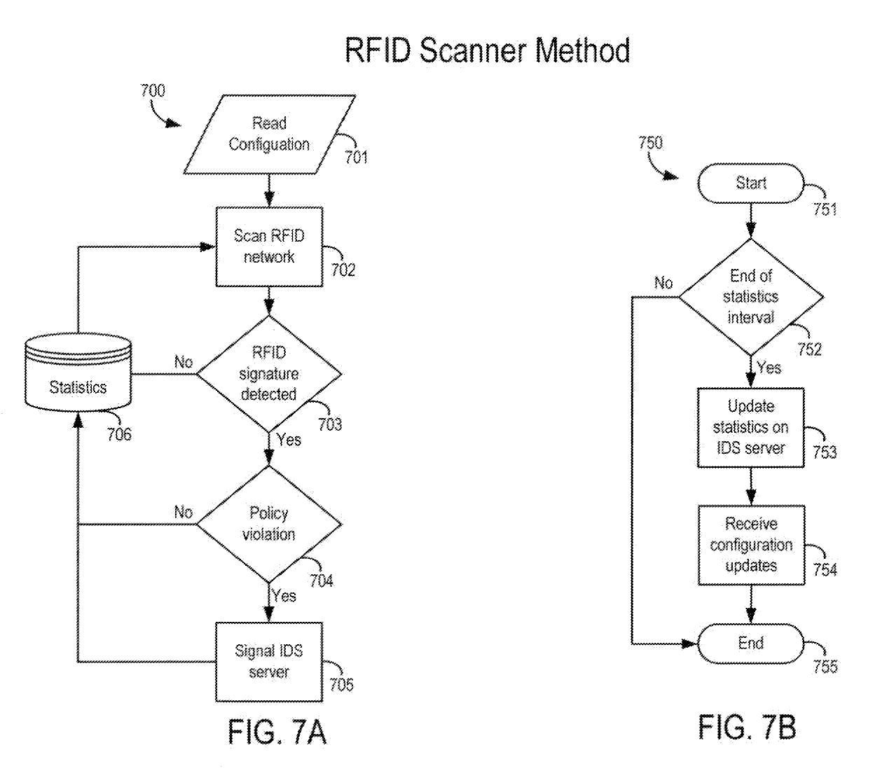

FIG. 7A is a flowchart illustrating an operational scenario 700 of an RFID sensor scanning an RFID network. Scenario 700 can be implemented by the sensor 410 or the reader/sensor 415 and the server 405, 505 as depicted in FIGS. 4, 5, 6A, and 6B.

The sensor reads the configuration, as depicted in step 701. The configuration includes information such as RFID policy, frequencies to monitor, connection to an intrusion detection server (IDS), period for reporting to the IDS, etc. The sensor scans the RFID network, as depicted in step 702. The sensor continuously scans the RFID infrastructure while enabled receiving all RFID queries from readers and responses from tags.

The sensor detects an RFID signature, as depicted in step 703. The RFID signature can include a reader querying tags or a tag responding to a reader. If no signature is detected, then the sensor stores statistics in step 706 and continues to scan the RFID network in step 702. The sensor can store statistics of the time interval where no signature is detected and provide this to the IDS periodically where the period is adjustable.

If a signature is detected, the sensor checks to see if a policy violation has occurred as depicted in step 704. If no policy violation has occurred, then the sensor stores statistics in step 706 and continues to scan the RFID network in step 702. A policy violation can include any RFID communication in the case where the policy forbids RFID communication, a rogue reader interrogating tags, and a tag communicating in response to a rogue reader.

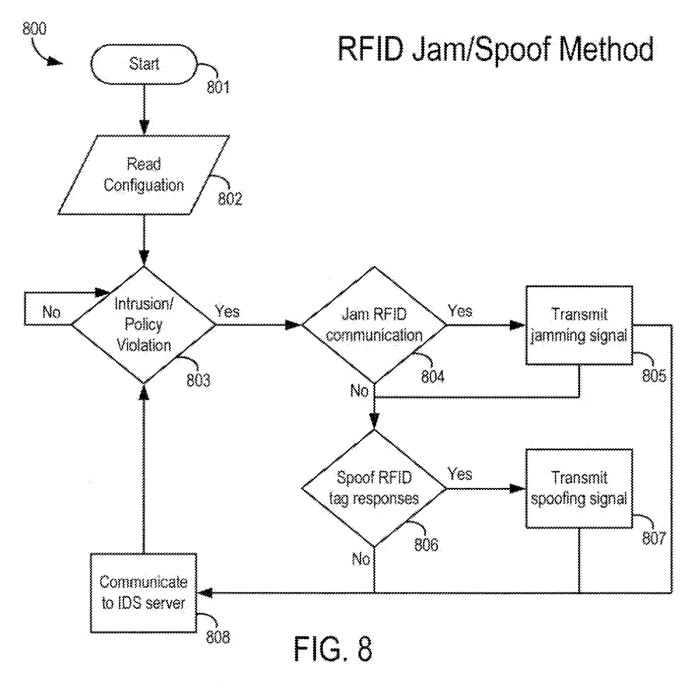

If a policy violation occurs, the sensor signals the IDS server and stores the statistics in step 706 and continues to scan the RFID network in step 702. Policy violations can trigger the IDS or the sensor to implement defensive measures as depicted in FIG. 8.

FIG. 7B is a flowchart illustrating an operational scenario 750 of an RFID sensor communicating with an intrusion detection server. Scenario 750 can be implemented by the sensor 410 or the reader/sensor 415 and the server 405, 505 as depicted in FIGS. 4, 5, 6A, and 6B. The sensor communicates to the server through a network which can include an Ethernet local area network (LAN), a wireless LAN, or the Internet.

The scenario 750 starts as depicted in step 751. The scenario 750 can start based on configuration information as depicted in step 701 of FIG. 7A. This can include a predetermined reporting period where the sensor communicates to the server at set intervals or when an event such as a rogue RFID transmission has occurred.

The sensor checks to see if the statistics interval has ended, as depicted in step 752. If the interval has ended, the sensor updates its statistics on the IDS server, as depicted in step 752. The sensor receives configuration updates from the server, as depicted in step 754. These updates can include new policy information. If the interval has not ended or after the configuration updates are received, the scenario 750 ends as depicted in step 755.

FIG. 8 is a flowchart illustrating an operational scenario 800 of an RFID sensor implementing defenses in an RFID system. The scenario 800 starts as depicted in step 801. The sensor reads configuration information, as depicted in step 802. The configuration includes information such as RFID policy, defensive measures and conditions for implementation, frequencies to monitor, connection to an intrusion detection server (IDS), etc.

The sensor checks for intrusions or policy violations in the RFID network, as depicted in step 803. If no intrusion or policy violation occurs, the sensor remains at step 803. An example intrusion can include an unauthorized or rogue reader attempting to interrogate tags. An example policy violation can include a reader attempting to interrogate tags during a certain time period when no interrogation is authorized.

If an intrusion or policy violation occurs, the sensor checks to see if it should jam RFID communication based on the configuration as depicted in step 804. Jamming of RFID communications disrupts all RFID communication in the vicinity of the sensor. If the sensor is configured to jam RFID communications, then the sensor transmits a jamming signal as depicted in step 805. After transmitting the jamming signal, the sensor provides the data and results of the jamming defense to the IDS server by communicating to the IDS server as depicted in step 808.

If the sensor is not configured to jam RFID communication or after transmitting a jamming signal die sensor checks to see if it should spoof RFID tag responses based on the configuration as depicted in step 806. If the sensor is configured to spoof RFID tag responses, then the sensor transmits a spoofing signal as depicted in step 807. A spoofed signal includes a fake RFID response to mislead the rogue or unauthorized reader. After transmitting the spoofing signal or if the sensor is not configured to spoof RFID tag responses, the sensor communicates with the IDS server as depicted in step 808. After step 808, the sensor waits until another intrusion or policy occurs as depicted in step 803.

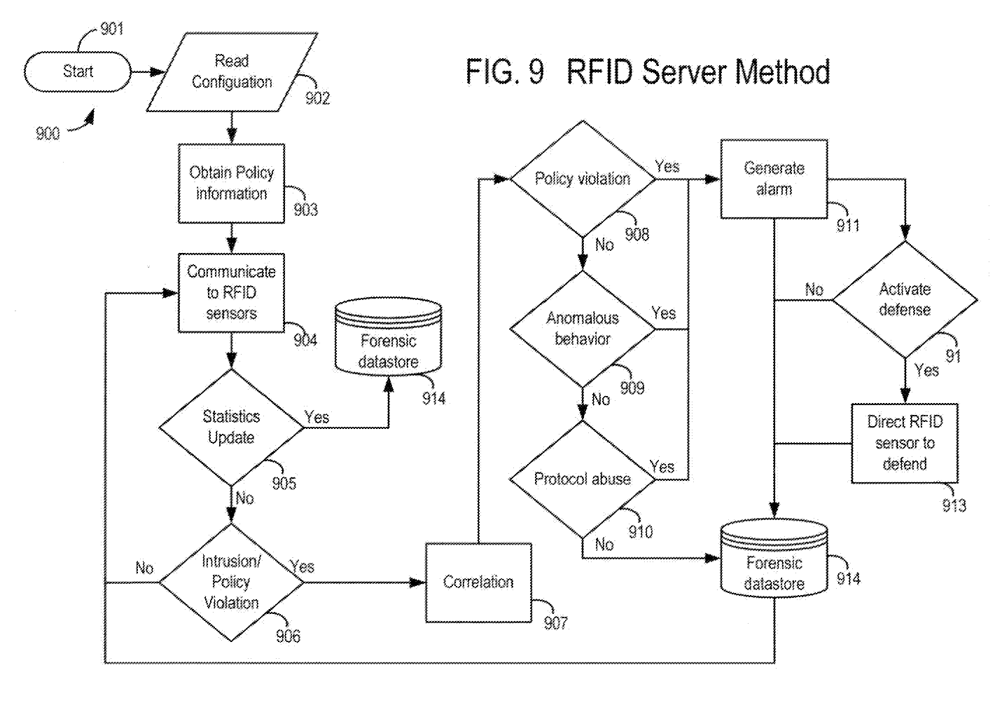

FIG. 9 is a flowchart illustrating an operational scenario 900 of a local or master intrusion detection server. The server can include the local server 405 or the master server 505 as depicted in FIGS. 4 and 5. The server starts as depicted in step 901. This can include booting or initializing the server. The server reads die configuration information, as depicted in step 902. The configuration includes information such as RFID policy, defensive measures and conditions for implementation, frequencies to monitor, connection to an intrusion detection server (IDS), connection information to sensors and reader/sensors, etc.

The server obtains policy information, as depicted in step 903. Policy information includes the reader, sensors, and sensors-readers connected to the server; RFID policies such as authorized readers and locations; and defensive mechanisms. The server communicates to the RFID sensors, as depicted in step 904.

While in operation, the server remains in communication to the sensors over & network connection. If a sensor has statistics to update as depicted in step 905, then the server receives the statistics and logs them in a forensic data store as depicted in step 914. If there is no intrusion or policy violation, then the server remains in communication with the sensors as depicted in step 904.

If the server is notified of an intrusion or policy violation as depicted in step 906, then the server correlates the data received from one or more sensors as depicted in step 907. The server receives notification of events from the RFID sensors, which may include notification of policy violations and intrusions or it may also include anomalous behavior and protocol abuse. Correlation is simultaneously analysing different sets of variables, statistics and states obtained, from multiple RFID sensors, the forensic data store, and RFID readers to obtain a better overall picture of threats, attacks and policy violations against the network. Correlation additionally involves looking at the received events from one or more sensors to determine if the event is the same or different and the type of event. Additionally, the server can determine the location of an RFID reader based on wireless triangulation methods after receiving and correlating the events.

In step 908, the server determines if a policy violation has occurred. A policy violation occurs when certain events that are not permitted per defined, policy are detected. Example policy violations include any RFID activity, interrogation by a rogue reader, after-hours access to RFID tags, among others. For example, the policy could be that all wireless transmissions have to be encrypted and if a clear text transmission is detected by sensors this is a policy violation. Another example can be that policy prohibits RFID scans on Sundays, and a policy violation occurs if a scan is detected on Sunday. Policy can be updated or changed from the server. If a policy violation occurs, then the server generates an alarm as depleted in step 911.

If no policy violation has occurred, then the server looks for anomalous behavior as depicted in step 909. Anomalous behavior is any behavior that is not within the normal operation of the RFID system. The system can have pre-defined thresholds or learn these thresholds over time. For example, the system may learn that number of RFID scans after 9:00 PM is close to zero. It would be anomalous behavior if 1000 scans are detected at one particular time past 9:00 pm, Additionally, the system can have a pre-defined threshold of for example three attempts before successful user authentication. It would be anomalous behavior if four attempts are detected. Anomalous behavior can be updated or changed from the server based on operations and history. If anomalous behavior is defected, then the server generates an alarm as depicted in step 911.

If anomalous behavior is not detected, then the server looks for protocol abuse as depicted in step 910. Several protocols assume co-operative client behavior. Protocol abuse is when a user or node gets malicious and tries to exploit loopholes unfairly. For example, if an RFID tag responds to all queries it can confuse the reader. There is no protection against this and it would be an abuse of protocol. If protocol abuse is detected, then the server generates an alarm as depicted in step 911.

The alarm can include an audible notification such as a sound or a visual notification such as a pop-up screen on the server's user interface. Folio wing the generation of an alarm in step 911, the server determines if a defense should be activated based on the policy as depicted in step 912. The defenses can include spoofing RFID tag responses, jamming the RFID channel, and programming RFID tags in quiet mode. If the defense is activated, then the server directs the RFID sensors to defend as depicted in step 913.

The server logs data to the forensic data store if no defense is activated, after the alarm is generated, and after directing the sensors to defend. The data store can include local or external storage connected to the server. After step 914, the server returns to communicating with the RFID sensors as depicted in step 904.

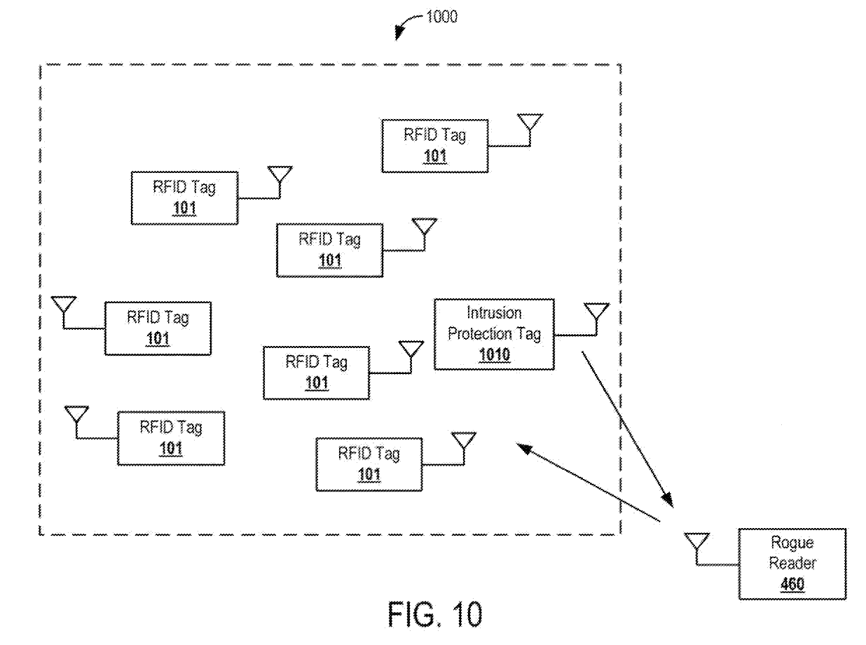

FIG. 10 is a block diagram of an exemplary embodiment of an RFID system 1000 including an intrusion protection system (IPS) tag 1010 for defending against RFID tag interrogation System 1000 includes several objects tagged with RFID tags 101 and one intrusion protection tag 1010. A rogue reader 460 is interrogating the RFID tags 101; however the tag 1010 disrupts, misleads, or jams the reader 460 to prevent interrogation.

Intrusion protection system tags 1010 are special tags designed to prevent unauthorized tag scans when tagged objects are not in the vicinity of an RFID sensor. For example, tags 1010 could be used while tagged objects are in transit outside of a warehouse. The tags 1010 can be designed to look identical to RFID tags 101 to prevent unauthorized removal.

Intrusion protection system tags 1010 include a power supply and local memory. The power supply can be an internal battery or backscatter from the antenna. Once activated, tags 1010 are configured to respond to any reader immediately. Tags 1010 could be activated by peeling off a label by sending a code, by naming on the power, among other methods.

Tags 1010 can mimic the response of a regular RFID tag and provide for adjustable output power. Adjusting the output power allows range to be controlled as well as better mimicking of spoofed responses. Spoofed responses happen when the tags 1010 try to impersonate say the response of another tag in order to actively defend against an intrusion attempt. Spoofed responses allow the tag 1010 to disrupt or contuse a reader. For example, the tag 1010 can be configured to respond, to any query and provide Misleading or wrong information.

Additionally, the tag 1010 can be configured to confuse readers with collisions or to jam the RFID channel completely. For example, the tag 1010 can be used to disrupt or to deny all RFID communications. This can be used where tagged objects are in transit or in a department store showroom.

The tag 1010 can be configured to log reader activity in local memory and to communicate this activity with an RFID intrusion protection server. The tag 1010 can be configured to communicate to the server through a universal serial bus (USB), Ethernet, and Wireless connection. The server can download RFID activity from the tag 1010 to determine if there was any RFID activity while the tag 1010 was active.

The memory on the tag 1010 can be scaled, depending on the application and the sophistication of the tag 1010. For example, the tag 1010 could be solely used to prevent all interrogations such as in the example of a grocery bag. Here, the tag 1010 would require little or no local memory because all RFID communication is disrupted or denied. Alternatively in a supply chain example, the tag 1010 could require memory to store all scans that are received while tagged objects are in a shipping container.

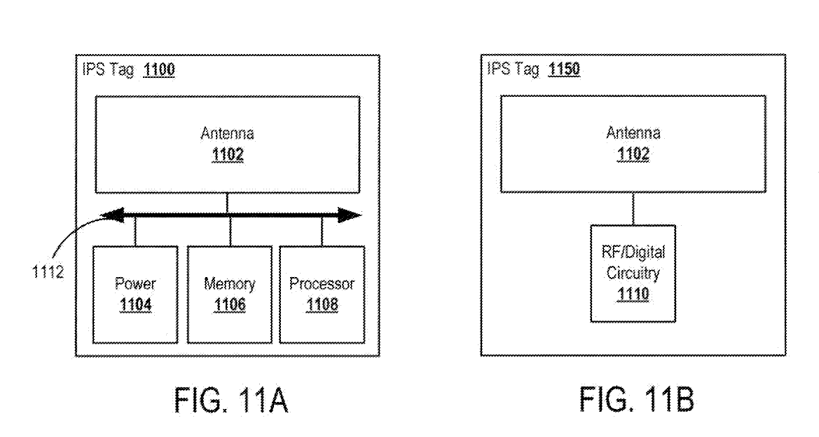

FIGS. 11A-11B are schematic diagrams of exemplary embodiments of an intrusion protection system (IPS) tag. FIG. 11A depicts an IPS tag 1100 configured with an antenna 1102, power 1104, memory 1106, and a processor 1108. The tag 1100 can be used where active monitoring and synchronisation with a server is required. Example uses include monitoring a shipping, container. FIG. 11B depicts an IRS tag 1150 configured with an antenna 1102 and radio frequency (RF)/digital circuitry 1110. The tag 1150 can be used to defend individual objects in a small vicinity. For example, the tag 1150 could be worn by a person or placed in a grocery bag.

The antenna 1102 is configured to receive RFID queries and to transmit signals. The antenna 1102 can be configured to power the tag through backscatter. The antenna 1102 can be configured to transmit an adjustable output power and to transmit a signal to collide with unauthorized reader's interrogations or a signal to jam the RFID channel. In the tag 1100, the antenna 1102 is connected to a local interlace 1112 to enable communication to the other components 1104, 1106, 1108. In the tag 1150, the antenna is connected directly to the RF/digital circuitry 1110.

Tag 1100 includes power 1104 which can include a battery. The battery can be configured to power the tag 1100 for a certain period of time. The tag 1100 can be disposable when the battery is used, or the battery could be replaced with a new battery. The tag 1150 is a passive RFID tag and utilizes backscatter from the antenna 1102 for power.

Tag 1100 includes memory 1106 connected to die local interface 1112 for storage of firmware to operate the tag 1100 and to store RFID activity. The memory 1106 is configured based on the application of the tag 1100. For example, in a shipping container the tag 1100 may require memory 1106 and power 1104 to operate and record RFID activity over a shipping period. The tag 1150 does not include memory to record RFID activity.

The processor 1108 is included in the tag 1100 to operate the tag 1100, to store activity, and to enable defenses. Additionally, the processor 1108 enables communications to the server through a communications interface. The processor 1108 can implement the defenses such as jamming and collisions based on predetermined configuration information. The tag 1150 Includes RF/digital circuitry 1110 configured to respond to a RFID query with either a collision or a jamming signal.

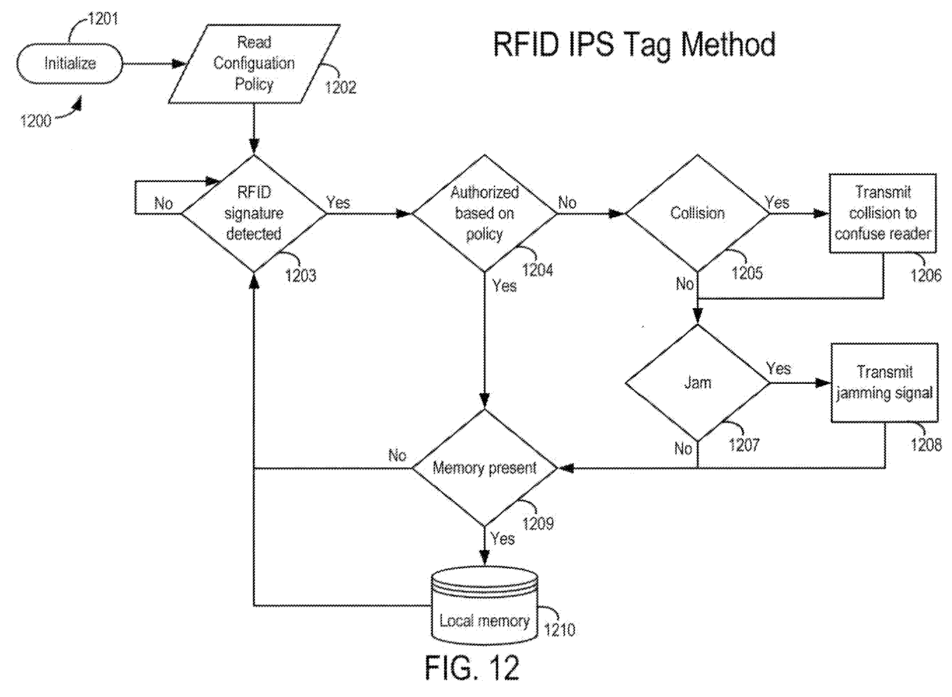

FIG. 12 is a flowchart Illustrating an operational scenario 1200 of an intrusion protection system (IPS) tag. The scenario 1200 is initialized as depicted in step 1201. Initialization can include peeling the tag off and affixing it to an object, enabling power, or turning it on through an on/off switch. The tag reads configuration policy, as depicted in step 1202. The configuration policy can include responses to tag interrogation. The tag detects RFID signatures, as depicted hi step 1203. If no signature is detected, the tag remains at step 1203.

If a signature is detected, the tag determines if the signature is authorized based on the policy as depicted in step 1204. For example, an active tag with a processor may be configured to determine if a reader is authorized is not. A passive tag may be set to a policy of no RFID interrogation and bypass this step completely and go to step 1205.

If there is an unauthorized RFID signature, the tag checks to see based on its configuration information if it should implement a collision defense as depicted in step 1205. If so, the tag transmits a collision to confuse the reader as depicted, in step 1206. For example, a collision may include a response to any tag query to prevent the reader from accessing a tag. After the collision is transmitted or if no collision is transmitted, the tag checks to see based on its configuration information if it should jam the RFID channel as depicted in step 1207. If so, then the tag transmits a jamming signal as depicted in step 1208. A jamming signal can include a powerful response transmitted continuously to block all RFID communications in the vicinity of the tag.

If the signature is authorized or after implementing the defense, the tag cheeks to see if memory is present as depicted in step 1209. If there is local memory to the tag, then the tag stores the event in local memory as depicted in step 1210. Following storage in local-memory or if there is no local memory, then the tag returns to step 1203 to await for the next RFID signature to be detected.

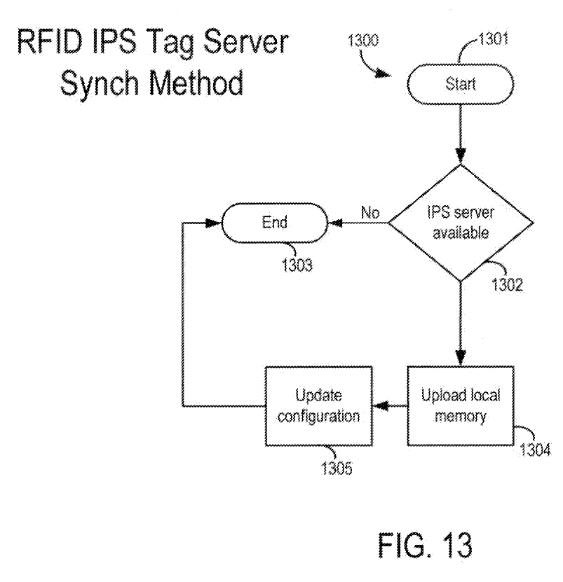

FIG. 13 is a flowchart Illustrating an operational scenario 1300 of an intrusion protection system (IPS) tag synchronising, with, an intrusion protection, server. The scenario 1300 starts as depicted in step 1301. The tag may be configured to connect to the server periodically if a connection is available or manually if die user connects the tag to the server. The tag checks to see if the server is available, as depicted in step 1302. If no server is available, then scenario 1300 ends as depicted in step 1303.

If the server is available, then the tag uploads its local memory to the server as depicted in step 1304. Next, the tag receives an updated configuration from the server as depleted in step 1305. Finally, the scenario 1300 ends as depicted in step 1303. The correction to the server can include for example a direct connection (e.g. USB, serial port, etc.) or a network connection (e.g. Ethernet, Wireless LAN).

What is claimed is:

1. A method for monitoring radio frequency identification (RFID) networks for intrusion and policy violations with RFID sensors, the method comprising the steps of:
a) setting configuration and policy information;
b) scanning for RFID transmissions;
c) logging statistics to a data store over a set time interval;
d) determining the existence of intrusions or policy violations;
e) generating an alarm responsive to any of intrusions and policy violations; and
f) repeating steps b) through, d).

2. The method of claim 1, further comprising the step of signaling an intrusion protection server responsive to an intrusion and policy violation.

3. The method of claim 1, further comprising the step of updating the statistics and events in the data store on an intrusion protection server responsive to any of the end Of a statistics interval and a request from the server.

4. The method, of claim 1, further comprising the step of receiving configuration and policy updates from the server.

5. The method of claim 1, wherein steps a) through e) are performed by RFID sensors, RFID readers/sensors, and combinations thereof physically distributed throughout an RFID infrastructure.

6. The method of claim 2, further comprising the step of activating defenses responsive to any of intrusions and policy violations.

7. The method of claim 6, wherein the defenses comprise jamming the RFID channel, spoofing RFID tag responses, and combinations thereof.

8. The method of claim 7, wherein the jamming comprises transmitting a jamming signal at adjustable power to disrupt RFID communications.

9. The method of claim 7, wherein the spooling comprises transmitting a spoofed signal configured to mislead an RFID reader.

10. The method of claim 1, further comprising the step of generating an alarm responsive to any of protocol abuse and anomalous behavior.

11. A radio frequency identification (RFID) sensor, the sensor comprising:
an antenna configured, to receive and transmit wireless transmissions of signals in an adjustable range of frequencies;
memory capable of storing received data and program data;
a system processor comprising one or more processing elements, wherein the system processor is in communication with the antenna and the memory and wherein the system processor's one or more processing elements are programmed or adapted to:
i) extract RFID data into one or more logical, units from signals received by the antenna;
ii) inspect each extracted logical unit;
iii) store information derived from the inspection of each logical unit in memory; and
iv) communicate the information to a server.

12. The sensor of claim 11, further comprising a communications interface configured to communicate with an intrusion protection server, wherein the communications interface transmits information to the server and receives policy and configuration updates from the server.

13. The sensor of claim 12, wherein the communications interface is a secure interface comprising any of an Ethernet port and a wireless local area network interlace.

14. The sensor of claim 12, wherein the system processor is further programmed or adapted to detect RFID readers interrogating RFID tags based on the information, and signal the server responsive to foe detection of an RFID reader.

15. The sensor of claim 14, wherein the sensor is configured to transmit a jamming signal to disrupt RFID communications and a spoofing signal to confuse RFID readers responsive to any of a detection of an RFID reader, a policy violation, an intrusion, and a request from the server.

16. The sensor of claim 11, wherein the system processor is further programmed or adapted to interrogate RFID tags.

17. The sensor of claim 12, further comprising a user interface accessible through any of a screen on the sensor and a network connection through the communications interface.

18. A server-based method for monitoring radio frequency identification (RFID) networks for intrusion and policy violations, the method comprising the steps of:
a) obtaining configuration and policy information;
b) establishing communication with a plurality of RFID sensors;
e) receiving events from the plurality of RFID sensors;
d) correlating events from the plurality of RFID sensors;
e) generating an alarm responsive to the correlating step; and
f) repeating steps c) through e)

19. The method of claim 18, wherein the obtaining step comprises either manually or automatically receiving configuration information torn the RFID infrastructure, the RFID infrastructure comprises any of RFID sensors, RFID readers, RFID sensors, and combinations thereof.

20. The method of claim 19, wherein configuration information comprises any of authorized readers, protocols, sensor locations, reader locations, network settings, statistics intervals, and combinations thereof.

21. The method of claim 19, wherein policy information comprises any of system usage time, tag lock policy, tag kill policy, tag write policy, query thresholds, defense activation conditions, and combinations thereof.

22. The method of claim 18, wherein the receiving step comprises receiving any of statistics, events, network configuration information, policy information, and combinations thereof.

23. The method of claim 22, wherein the correlating step comprises analyzing events and statistics from the plurality of RFID sensors to determine policy violations, anomalous behavior, protocol abuse, and combinations thereof.

24. The method of claim 18, further comprising the step of activating a defense responsive to generating an alarm, the defense comprising any of a jamming defense, a spoofing defense, and RFID tag quiet mode.

25. The method of claim 24, wherein the activating step comprises directing one or more RFID sensors to implement the defense.

26. The method of claim 18, further comprising the step of storing events and alarms in a data store.

27. The method of claim 23, further comprising the step of locating the location of an RFID reader based on the correlated events.

28. The method of claim 18, wherein the alarms are generated through one of SNMP traps, syslog messages, email, and SMS.

29. The method of claim 18, further comprising the steps of communicating events and alarms to a master server.

30. A radio frequency identification (RFID) intrusion protection system, the system comprising:
a local intrusion protection server connected to a network;
a data store connected to the server;
wherein, the server is configured to:
establish communications with a plurality of RFID sensors connected to the network;
obtain configuration and policy from the network and RFID infrastructure connected to the network;
receive events and statistics from the plurality of RFID sensors;
store events and statistics in the data store; and
correlate events to identify RFID readers, policy violations, and intrusions.

31. The system of claim 30, further comprising a master intrusion protection server connected through the network to one or more local intrusion protection servers, wherein the master server is configured to perform the functions of the one or more local servers and store events and statistics from the one or more local servers.

32. A tag-based method of intrusion protection for radio frequency identification (RFID) networks, the method comprising the steps of:
initializing an intrusion protection RFID tag; and
activating a defense responsive to the RFID signature, the defense comprising one of a jamming signal and a collision signal.

33. The method of claim 32, wherein die initializing step comprises one of peeling a sticker off the tag, turning the tag on, and adding a battery to the tag.

34. The method of claim 32, further comprising the step of logging RFID activity in local memory.

35. The method of claim 34, further comprising the step of synchronizing with a server, wherein synchronizing comprises sending the local memory to the server.

36. The method of claim 32, wherein the jamming signal defense comprises transmitting a signal to block all RFID communications in the vicinity of the intrusion protection RFID tag, wherein the jamming signal can be transmitted at adjustable power.

37. The method of claim 32, wherein the collision signal defense comprises transmitting a signal in response to any RFID interrogation to confuse an RFID reader.

38. The method of claim 32, wherein the activating step is performed responsive to an unauthorised RFID signature, the unauthorized RFID signature is detected by the intrusion protection RFID tag responsive to a preconfigured policy.

39. An intrusion protection, radio frequency Identification (RFID) tag configured to protect RFID tags located substantially in the same vicinity as the intrusion protection RFID tag, the tag comprises:
an antenna configured to transmit and receive RFID communications at a set frequency, the frequency responsive to the RFID protocol;
a processor coupled to the antenna, the processor configured to:
detect RFID signatures; and
transmit a jamming or a collision signal responsive to an RFID signature.

40. The tag of claim 39, further comprising local memory configured to store RFID events and statistics, and local power.

41. The tag of claim 39, wherein the processor is powered based on backscatter power received from the antenna responsive to an RFID query.
